(19) United States
(12) Patent Application Publication
(10) Pub. No.: US 2009/0210611 A1
(43) Pub. Date: Aug. 20, 2009

(54) STORAGE SYSTEM AND DATA WRITE METHOD

(76) Inventor: Nagamasa MIZUSHIMA, Machida (JP)

Correspondence Address: MATTINGLY & MALUR, P.C., 1800 DIAGONAL ROAD, SUITE 370, ALEXANDRIA, VA, 22314, US

(21) Appl. No.: 12/105,076

(22) Filed: Apr. 17, 2008

(30) Foreign Application Priority Data
Feb. 20, 2008 (JP) 2008-038176

(51) Int. Cl. G06F 12/00

(52) U.S. Cl. 711/103; 711/E12.001

(57) ABSTRACT

The size of a memory management unit in a low-performance non-volatile memory device is maintained, and the size of write data is compared with the size of the memory management unit. If the size of the write data is smaller than that of the memory management unit, the write data is cached by the high-performance non-volatile memory device; or if the size of the write data is not smaller, the write data is written to the low-performance device. Subsequently, a plurality of address values for the write data cached by the high-performance device are referred to; an address segment that is equal to the size of the memory management unit and in which the cached address values are consecutive; and data contained in that address segment is copied from the high-performance device to the low-performance device.

### CROSS-REFERENCES TO RELATED APPLICATIONS

This application relates to and claims priority from Japanese Patent Application No. 2008-038176, filed on Feb. 20, 2008, the entire disclosure of which is incorporated herein by reference.

### BACKGROUND

1. Field of the Invention

The present invention relates to a storage system equipped with semiconductor storage apparatuses using electrically-rewritable non-volatile memory, and also to a data write method for such a storage system. More particularly, this invention relates to a storage system for storing data according to write performance characteristics of semiconductor storage apparatuses, and also relates to a data write method for such a storage system.

2. Description of Related Art

U.S. Pat. No. 7,136,973 discloses a method for enhancing write performance in a storage apparatus composed of two types of non-volatile devices with a difference in performance, Using that method, a specified amount of write data is cached by a high-performance non-volatile device during a period until a low-performance non-volatile device becomes capable of writing the data; and then later that data is copied to the low-performance device and the write destination for subsequent write processing is also switched to the low-performance device. For example, the high-performance device is flash memory, and the low-performance device is a magnetic disk. Also, the above-mentioned “period before the low-performance non-volatile device becomes capable of writing the data” corresponds to the seek time for a magnetic head. The above-described storage apparatus is called a “hybrid hard disk.”

The case where the write method disclosed in U.S. Pat. No. 7,136,973 is applied to a storage system such as a semiconductor storage apparatus using flash memory as both high-performance and low-performance devices will be examined below. Whether data size is optimum or not is not considered in this method when controlling data copy from the high-performance device to the low-performance device. Therefore, as a problem that might occur in the storage system, there is a possibility that the rewritable life (approximately 100,000 times per memory block) of flash memory in the low-performance device may be wasted. This is because generally a low-performance flash memory storage apparatus is designed to rewrite its internal flash memory using a memory management unit (for example, 64 KB) previously set by internal control firmware of the low-performance flash memory storage apparatus. If the size of data to be copied between the relevant devices is 4 KB, 64-KB data obtained by adding 60-KB peripheral data (with no change) to that 4-KB data is processed and stored in the free space in the internal flash memory. This means that a wasteful data arrangement like above will be produced in the low-performance device. This will waste the rewritable life of the low-performance device. On the other hand, when writing data from outside to the high-performance device, the high-performance device generally controls data programming so that the minimum necessary data is stored in the internal flash memory. As a result, almost no wasteful data arrangement like above will be produced in the high-performance device.

### SUMMARY

The present invention was devised in view of the circumstances described above. This invention aims to suggest: a storage system that has high-performance device cache small-sized write data several times, and then writes it to a low-performance device, thereby reducing the average write processing time and enhancing write performance; and a data write method for such a storage system.

According to an aspect of the present invention, a storage system including a first non-volatile memory device with specified performance and a second non-volatile memory device with a higher performance than the specified performance is provided. This storage system includes: a size-maintenance unit for maintaining the size of a memory management unit to manage memory in the first non-volatile memory device; and a control unit for, in response to a write request from a host system, comparing the size of write data, for which the write request was made, with the size of the memory management unit; and temporarily writing the write data to the second non-volatile memory device if the size of the write data is smaller than the size of the memory management unit; or writing the write data to the first non-volatile memory device if the size of the write data is equal to or larger than the size of the memory management unit.

More specifically, a data write method having the following characteristics for a storage system composed of two types of non-volatile memory devices with a difference in performance is provided. The characteristics of this data write method is as follows; first, the size of a memory management unit in a low-performance non-volatile memory device is maintained. Next, the following steps are performed in response to a write request to the storage system. (1) The size of write data is compared with the size of the memory management unit. (2) If the size of the write data is smaller than that of the memory management unit, the write data is cached by the high-performance non-volatile memory device; or otherwise, the write data is written to the low-performance device. (3) Either one of the following steps (A) and (B), or both, are performed: (A) referring to a plurality of address values for the write data cached by the high-performance device; selecting an address segment that is equal to the size of the memory management unit and in which the address values are consecutive; and copying the write data contained in that address segment, from the high-performance device to the low-performance device; and (B) referring to a plurality of address values for the write data cached by the high-performance device; selecting an address segment that is equal to or smaller than the size of the memory management unit and contains a maximum number of address values; reading the write data that can be contained in the address segment from the high-performance device; reading write data from the low-performance device; creating consecutive data for the address segment; and writing the created consecutive data to the low-performance device.

With the storage system composed of two types of non-volatile memory devices with a difference in performance according to an aspect of the invention, small-sized write data is cached by the high-performance device several times and then written to the low-performance device. As a result, the advantageous effect of reducing the average write processing time and enhancing the write performance of the storage system can be obtained.

Furthermore, when the cache data is written to the low-performance device, writing data of a size possibly wasting the rewritable life of flash memory in the low-performance device is avoided. Therefore, the advantageous effect of improving the rewritable life of the flash memory in the storage system is obtained.

Other aspects and advantages of the invention will be apparent from the following description and the appended claims.

### BRIEF DESCRIPTION OF THE DRAWINGS

FIG. 1 shows the internal configuration of a consumer-type semiconductor storage apparatus according to each embodiment of the present invention.

FIG. 2 shows the internal configuration of an enterprise-type semiconductor storage apparatus according to each embodiment of the present invention.

FIG. 3A, 3B shows a data write processing method and write performance characteristics of the consumer-type semiconductor storage apparatus according to each embodiment of this invention.

FIG. 4A 4B shows a data write processing method and write performance characteristics of the enterprise-type semiconductor storage apparatus according to each embodiment of the invention.

FIG. 5 shows the internal configuration of a storage system according to each embodiment of the invention.

FIG. 6A, 6B shows the internal configuration of an SSD unit according to the first embodiment of the invention.

FIG. 7 shows the internal configuration of an SSD unit according to the second embodiment of the invention.

FIG. 8 is a flowchart illustrating a data write processing sequence of the storage system according to an embodiment of the invention.

FIG. 9 shows an example of the state where data that has been cached by the enterprise-type semiconductor storage apparatus according to an embodiment of the invention is written to the consumer-type semiconductor storage apparatus.

FIG. 10 shows another example of the state where data that has been cached by the enterprise-type semiconductor storage apparatus according to an embodiment of the invention is written to the consumer-type semiconductor storage apparatus.

### DETAILED DESCRIPTION OF PREFERRED EMBODIMENTS

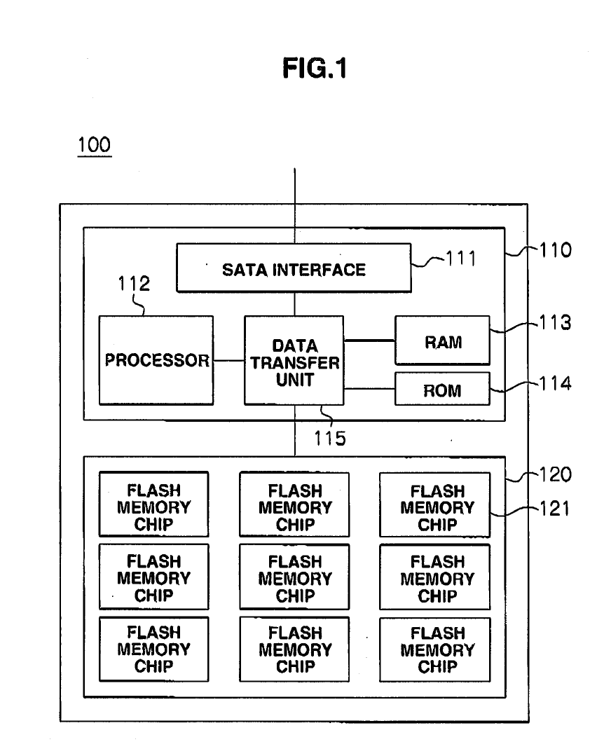

Each embodiment of this invention will be described below. First, regarding two types of semiconductor storage apparatuses mounted as user data storage media in a storage system in which the present invention is utilized, their respective internal hardware configurations and write performance characteristics will be explained below with reference to FIGS. 1-4. The semiconductor storage apparatus will be hereinafter referred to as a “Solid State Disk” and abbreviated to “SSD,”

The first SSD is a consumer-type SSD produced for general consumers (hereinafter referred to as a “C-SSD”). The second SSD is an enterprise-type SSD produced for business enterprises (hereinafter referred to as an “E-SSD”). The C-SSD is a product intended to obtain a profit with a “low-margin high-turnover” policy by cutting down the cost price and profitability ratio as much as possible and distributing a large amount of the product in the storage apparatus market for portable electronic equipment. Since inexpensive processors are used and memory resources are reduced to prioritize keeping the manufacturing cost low, the C-SSD has lower performance than the E-SSD.

On the other hand, the E-SSD is a product intended to satisfy high-end customer requirements by enhancing performance as much as possible. Since expensive components are used and intelligent control firmware is packaged to prioritize enhancing the performance, the manufacturing cost for the E-SSD is higher than that for the C-SSD. The E-SSD is mainly utilized in storage apparatuses for professional-use servers and the E-SSD market distribution not so large. Therefore, a high profitability ratio is set for the E-SSD. As a result, the price of a common E-SSD is approximately five times as high as the price of a C-SSD with the same capacity. This is similar to circumstances where there is a price difference between a consumer-type hard disk drive and an enterprise-type hard disk drive.

FIG. 1 shows the hardware configuration of a C-SSD 100. The C-SSD 100 includes a memory controller 110 and flash memory 120. The flash memory 120 stores data in a non-volatile manner. The memory controller 110 executes “reading,” “data write processing,” and “deleting” data in the flash memory 120. The memory controller 110 includes a processor 112, a SATA (serial ATA) interface 111, a data transfer unit 115, RAM 113, and ROM 114. The data transfer unit 115 contains bus logics and control logics for the flash memory 120 and is connected to other components 111-114 and the flash memory 120. The processor 112 controls the data transfer unit 115 according to control firmware stored in the ROM 114. The RAM 113 serves as transfer data buffer memory and control firmware work memory. The flash memory 120 is composed of a plurality of flash memory chips 121. The power for operating the entire C-SSD 100 is supplied from outside via the SATA interface 111.

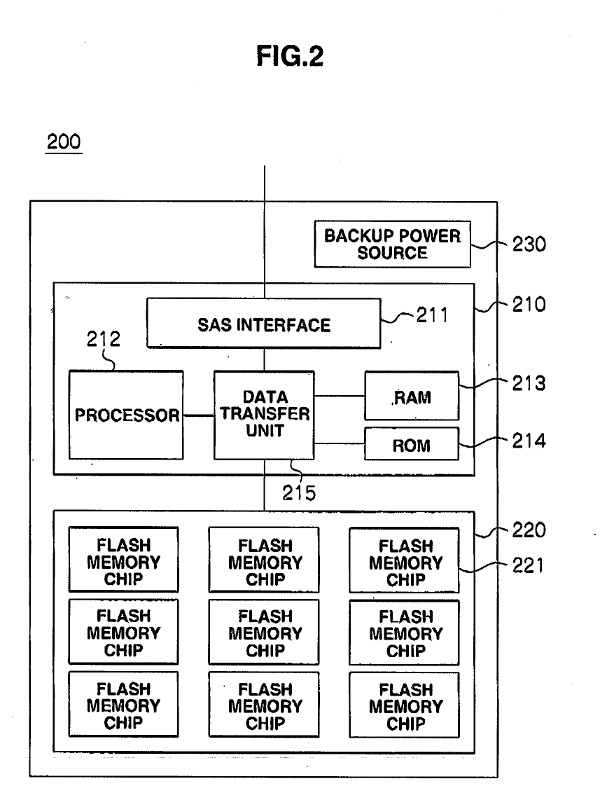

FIG. 2 shows the hardware configuration of an E-SSD 200. The E-SSD 200 includes a memory controller 210, flash memory 220, and a backup power source 230. The flash memory 220 stores data in a non-volatile manner. The memory controller 210 executes “reading,” “data write processing,” and “deleting” data in the flash memory 220. The memory controller 210 includes a processor 212, an SAS (serial attached SCSI) interface 211, a data transfer unit 215, RAM 213, and ROM 214. The data transfer unit 215 contains a bus logic and a control logic for the flash memory 220 and is connected to other components 211-214 and the flash memory 220. The processor 212 controls the data transfer unit 215 according to control firmware stored in the ROM 214. The RAM 213 serves as transfer data buffer memory and control firmware work memory. The flash memory 220 is composed of a plurality of flash memory chips 221.

The SAS interface 211 has two ports and is thereby capable of asynchronously accepting two independent accesses. If a failure occurs in the access path to one port, the other port can be used to continue the access.

The power for operating the entire E-SSD 200 is supplied from outside, basically via the SAS interface 211. However, if the external power supply is cut, a backup power source 230 supplies power to the E-SSD 200. If data to be written to the flash memory 220 remains in the RAM 213 when the external power supply is cut, the power from the backup power source 230 is utilized to write the data to the flash memory 220. No external access will be accepted until the cut external power supply is restored.

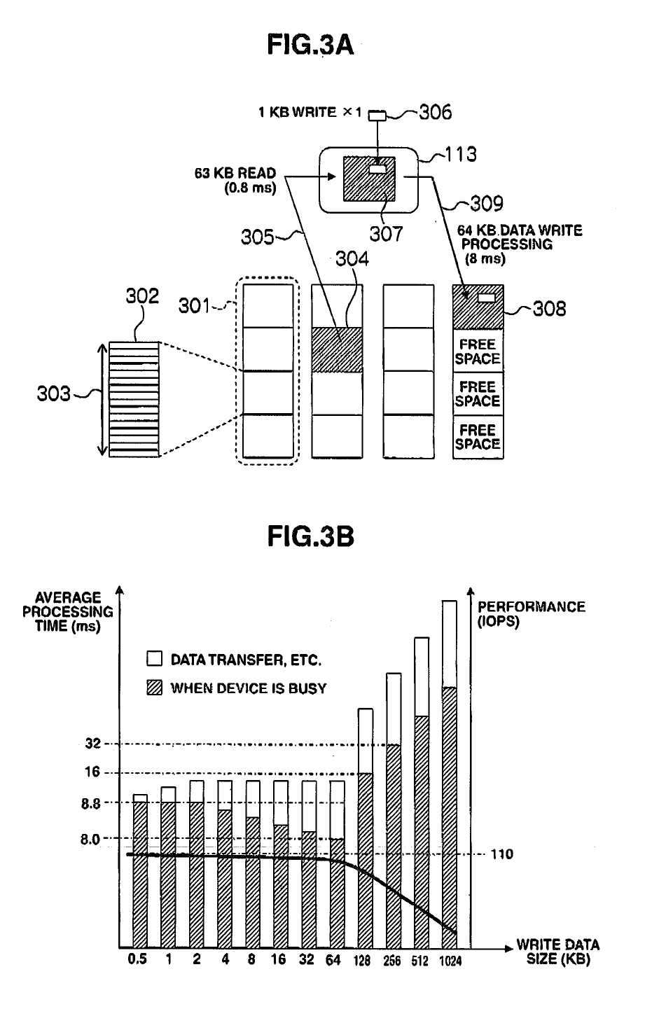

A data write processing method and performance characteristics of a C-SSD 100 will be described below with reference to FIG. 3A.

Each flash memory chip 121 is composed of a plurality of (for example, 4096) memory blocks 301. A memory block 301 is a flash memory deletion unit, and its size is, for example, 256 KB. The amount of time required to delete one memory block 301 is 2 ms. Also, each memory block 301 is composed of a plurality of memory pages 302 (for example, 64 pages). The memory page 302 is a data write processing unit for the flash memory 120, and the size of the memory page 302 is 4 KB. The amount of time required to execute data write processing for one memory page 302 is 500 μs, and the amount of time required to read one memory page 302 is 50 μs. In the C-SSD 100, a plurality of consecutive memory pages 302 (for example, 16 pages) constitutes a management unit 303. A logical address space for access from outside the C-SSD 100 is divided into units based on the size of the management unit 303, and the respective divided elements are associated with physical addresses (chip number, block number, and management unit number) assigned to the entire flash memory 120. This table for associating the divided elements with the physical addresses is referred to as an “address translation table.” This address translation table is updated by write access from outside the C-SSD 100. This is because the flash memory 120 is a memory element that cannot be structurally overwritten. Specifically speaking, data to undergo the data write processing has to be written to a yet-unwritten area different from the area of the pre-moved data, and the memory block 301 where the pre-moved data existed has to be deleted later. Therefore, the physical location of data at each logical address must be moved. The address translation table is mounted in the RAM 113, A group of plural memory pages (1.6 pages) constitutes the management unit, in order to reduce the number of elements to be associated with the physical addresses and economize on the memory resource amount.

If 1 KB data from outside the C-SSD 100 is written to the C-SSD 100, the processor 112 first selects a management unit 304 corresponding to an address segment containing the logical address of the relevant data and reads 63 KB data 307 that is non-write target data in that area (305). Then, the 1 KB write data 306 is set in the RAM 113, and the data write processing is executed for the 64 KB data and the obtained 64 KB data is stored in a management unit 308 to which no data has been written (309). The amount of time required for reading 305 is “16 times×50 μs=0.8 ms” to read 16 memory pages 302. The amount of time required for the data write processing 309 is “16 times×500 μs=8 ms” to write 16 memory pages 302. In other words, it takes 8.8 ms on a device level to write 1 KB data from outside the C-SSD 100. Incidentally, the effective average processing time is obtained by adding, for example, write data transfer time and occasional memory block deletion time to the above-mentioned 8.8 ms.

FIG. 3B shows the relationship between the size of data written to the C-SSD 100, average processing time (ms), and performance (IOPS: an average number of accesses per second) based on the above-described data write method. The processing time is shown with a bar graph indicated by the left vertical axis, and the performance is shown with a solid line graph indicated by the right vertical axis. Incidentally, the average processing time is shown by dividing the time into device-level processing time and other processing time (time required for data transfer and other processing).

If data (X KB) smaller than the size of the 64 KB management unit is written, (64-X) KB data will be read and a 64 KB management unit data arrangement will be produced in the C-SSD 100. So, it takes “8 to 8.8 ms” on a device level. Also, 128 KB data or 256 KB data is written, it takes 16 ms or 32 ms depending on the number of management units to undergo the data write processing inside the C-SSD 100. In this way, writing small-unit data to the C-SSD 100 involves moving peripheral data around the address of the relevant write data. Therefore, the limited rewritable life of the flash memory 120 inside the C-SSD 100 will be wasted unnecessarily.

The performance (IOPS) is obtained as the inverse number of the average processing time. If the size of write data is larger than the 64 KB management unit, the performance will steadily increase as the size of the write data decreases. On the other hand, if the size of the write data is smaller than the 64 KB management unit, the performance will converge to an asymptote of about 110 IOPS.

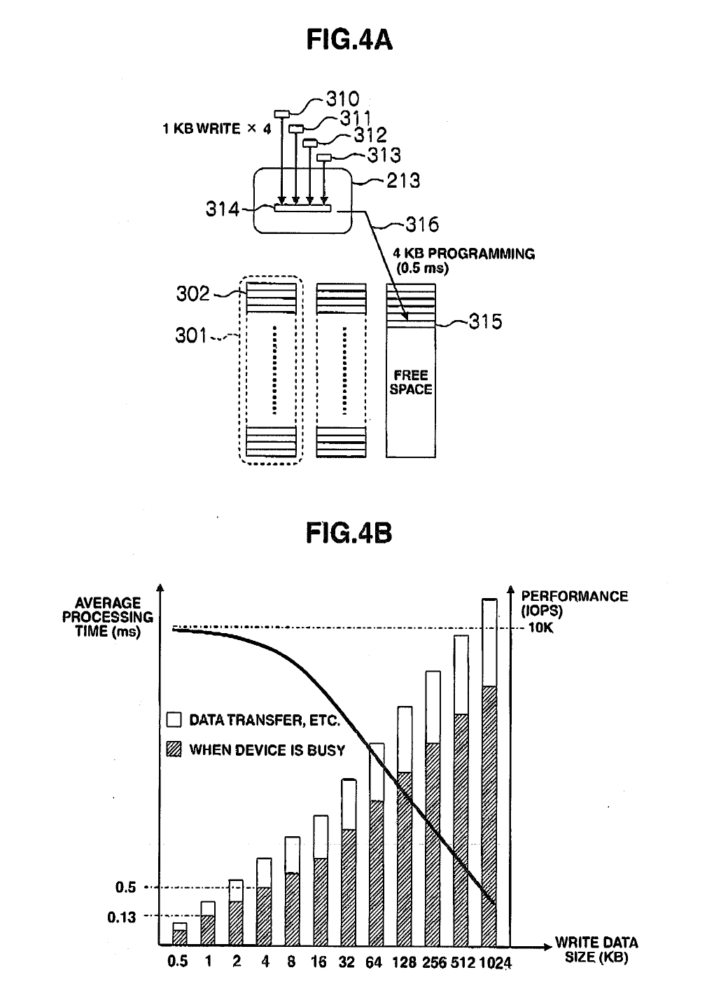

Next, a data write processing method and performance characteristics of the E-SSD 200 will be described below with reference to FIG. 4A.

Each flash memory chip 221 is the same as the flash memory chip 121 in the C-SSD 100 and is composed of a plurality of (for example, 4096) memory blocks 301. Each memory block 301 is composed of a plurality of memory pages 302 (for example, 64 pages). In the E-SSD 200, one memory page 302 constitutes a management unit. A logical address space for access from outside the E-SSD 200 is divided into units based on the size of the memory page 302, and the respective divided elements are associated with physical addresses (chip number, block number, and management unit number) assigned to the entire flash memory 220. This table for associating the divided elements with the physical addresses is referred to as an “address translation table.” This address translation table is updated by write access from outside the E-SSD 200. The address translation table is mounted in the RAM 213.

If 1 KB data from outside the E-SSD 200 is written to the E-SSD 200 many times, these pieces of data are buffered in the RAM 213 once. If four pieces of 1 KB data 310-313 included in the same page logical address exist in the buffer, these pieces are combined to create 4 KB page data 314. Then, the data write processing is executed for that data and the obtained data is stored in a yet-unwritten physical page 315 (316). The amount of time required for the data write processing 316 is “one time×500 μs=0.5 ms” to write one memory page. Since the above time corresponds to the amount of time required for writing 1 KB of date four times, the average time per 1 KB of data writing is approximately 0.13 ms. In other words, it takes 0.13 ms on a device level to write 1 KB data from outside the E-SSD 200.

If the 4 KB page data 314 cannot be created even by buffering write data until depletion of the RAM 213, the data short for is read from the flash memory 220 to complement the page data 314. This causes degradation of write performance. In other words, a product capable of buffering as many pieces of write data as possible in the RAM 213 exhibits higher write performance. Therefore, the E-SSD 200, designed to pursue high performance, is equipped with large-capacity RAM 213.

Incidentally, the effective average processing time is obtained by adding, for example, the write data transfer time and occasional memory block deletion time to the above-described processing time.

FIG. 4B shows the relationship between the size of data written to the E-SSD 200, average processing time (ms), and performance (IOPS) based on the above-described data write method. The processing time is shown with a bar graph indicated by the left vertical axis, and the performance is shown with a solid line graph indicated by the right vertical axis. Incidentally, the average processing time is shown by dividing the time into device-level processing time and other processing time (time required for data transfer and other processing).

Since the E-SSD 200 is controlled not to execute the data write processing for data (other than the data to be written to the E-SSD 200) to be stored in the flash memory 220 as much as possible, the limited rewritable life of the flash memory 220 will be consumed in the least wasteful manner.

The performance (IOPS) is obtained as the inverse number of the average processing time. The performance steadily increases as the size of the write data decreases. If the size of the write data is 0.5 KB, which is a minimum write unit (one sector) on a disk drive, the performance reaches 10K IOPS. This is approximately 100 times as much as the maximum performance of the C-SSD 100.

Based on the characteristics of the C-SSD 100 and the E-SSD 200 described above, embodiments of the present invention will be described below in detail.

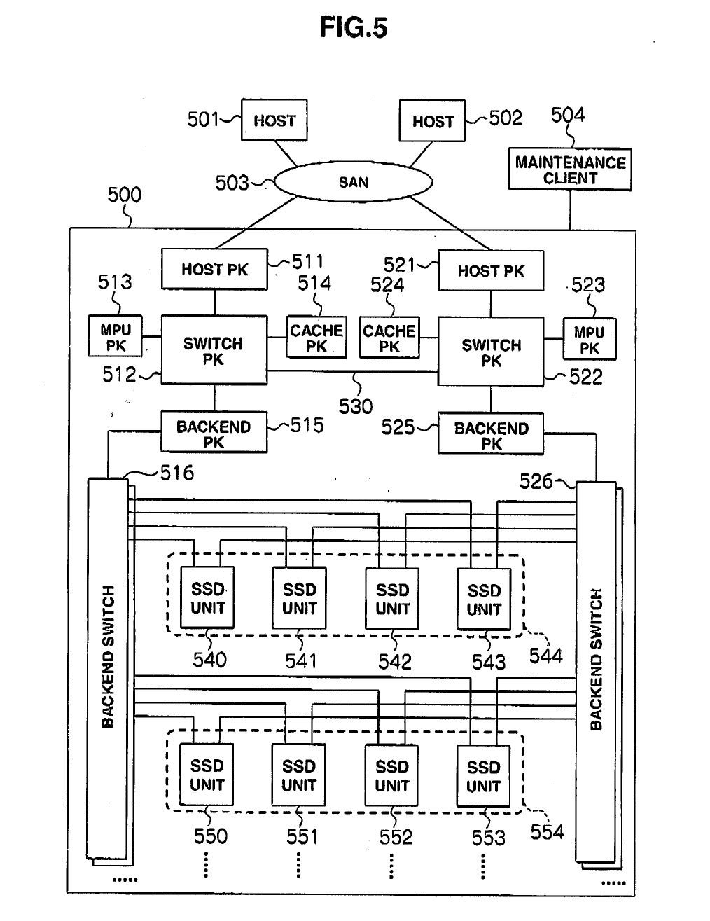

FIG. 5 shows the internal configuration of a storage system 500 to which the present invention is applied. The storage system 500 includes host packages (hereinafter referred to as “host PK(s)”) 511 and 521, MPU (microprocessor unit) PKs 513 and 523, cache PKs 514 and 524, and backend PKs 515 and 525; and the respective PKs are connected to the corresponding switch PK 512, 522. Each PK in the storage system 500 has a redundant (dual) configuration.

The host PK 511, 521 is a package containing an I/F controller for, for example, Fibre Channel or iSCSI, as a host I/F. The host PKs 511, 521 of the storage system 500 are connected to a plurality of hosts 501, 502 via a SAN (Storage Area Network) 503.

The MPU PK 513, 523 is a package containing an MPU for controlling the storage system 500, memory for storing control firmware and structural information about the storage system, and a bridge for connecting the MPU and the cache to the switch PK 512, 522.

The cache PK 514, 524 is a package containing cache memory that is a temporary storage area for user data to be stored in the storage system 500, and a cache controller for connecting the cache with the switch PK.

The backend PK 515, 525 is a package containing an I/F controller for controlling a plurality of SSD units (including 540-543 and 550-553) in the storage system 500. The I/F controller for the backend PK 515, 525 is connected via the backend switch 516, 526 to the plurality of SSD units (such as 540-543 and 550-553). The backend switch 516, 526 is composed of a SAS-compliant host bus adapter and expander and has a function supporting both a SAS interface and a SATA interface.

The SSD unit (such as 540-543 and 550-553) is a storage device unit containing the C-SSD 100, the E-SSD 200, or both of them as a pair. Each SSD unit (such as 540-543 or 550-553) has a SATA or SAS interface with redundant (dual) ports. So, if a failure occurs in each package or one of the backend switches, user data in the SSD unit can be accessed via either one of the redundant ports. The common internal configuration of the SSD units (such as 540-543 or 550-553) will be explained later in detail.

The storage system 500 is designed to realize data redundancy by forming a RAID group with a plurality of SSD units in order to prevent user data loss due to a failure in the SSD units. For example, four SSD units 540-543 can be formed into a “RAID 5” type group 544 whose ratio of data to parity is 3:1; or 2×2 units of the SSD units 550-553 can be formed into a “RAID 0+1” type group 554.

The storage system 500 is connected to a maintenance client 504, and a user performs storage control such as creation of RAID groups as described above, through the maintenance client 504.

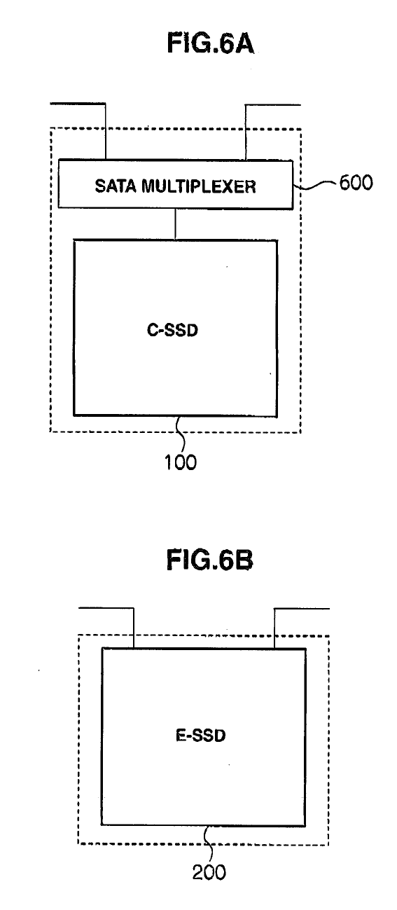

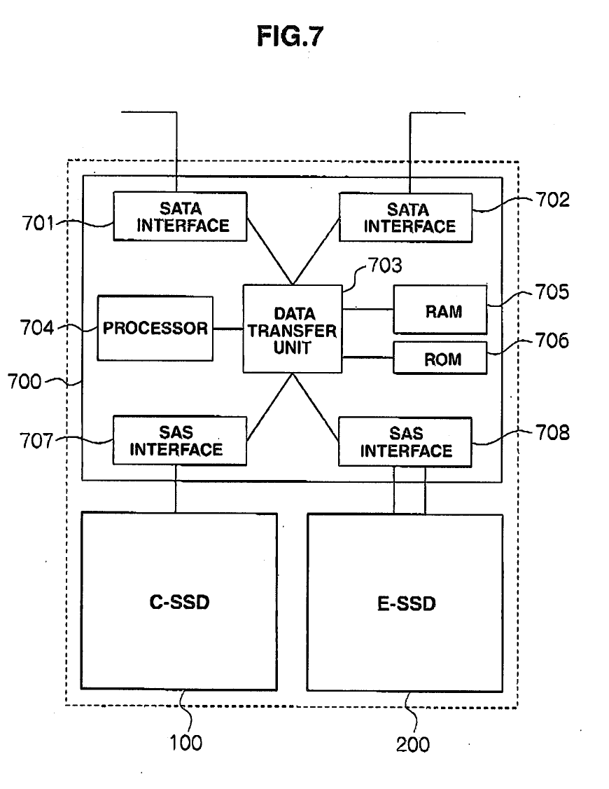

The common internal configuration of the SSD units (such as 540-543 and 550-553) will be described below with reference to FIGS. 6 and 7. FIG. 6 shows the internal configuration of the SSD unit according to the first embodiment of the present invention, while FIG. 7 shows the internal configuration of the SSD unit according to the second embodiment of the invention.

In the first embodiment, most (for example, 95%) SSD units employ a configuration formed with the C-SSD 100 connected to a SATA multiplexer 600 as shown in FIG. 6A (hereinafter referred to as “configuration A”), and the remaining few (for example, 5%) SSD units employ a configuration formed with the E-SSD 200 as shown in FIG. 6B (hereinafter referred to as “configuration B”). Every SSD unit of either configuration is made to participate in a redundant RAID group so that data stored in each SSD unit is protected. Incidentally, the SATA multiplexer 600 is an adapter apparatus that presents a one-port SATA interface as a two-port SATA interface in a pseudo manner.

In the first embodiment, the MPU PK 513 (or 523) executes write processing—basically performing substitute writing of data less than 64 KB, from among data to be written to the SSD units with configuration A, to the SSD units with configuration B, and then moving the plural pieces of data as a set from the SSD units with configuration B to the SSD units with configuration A as necessary.

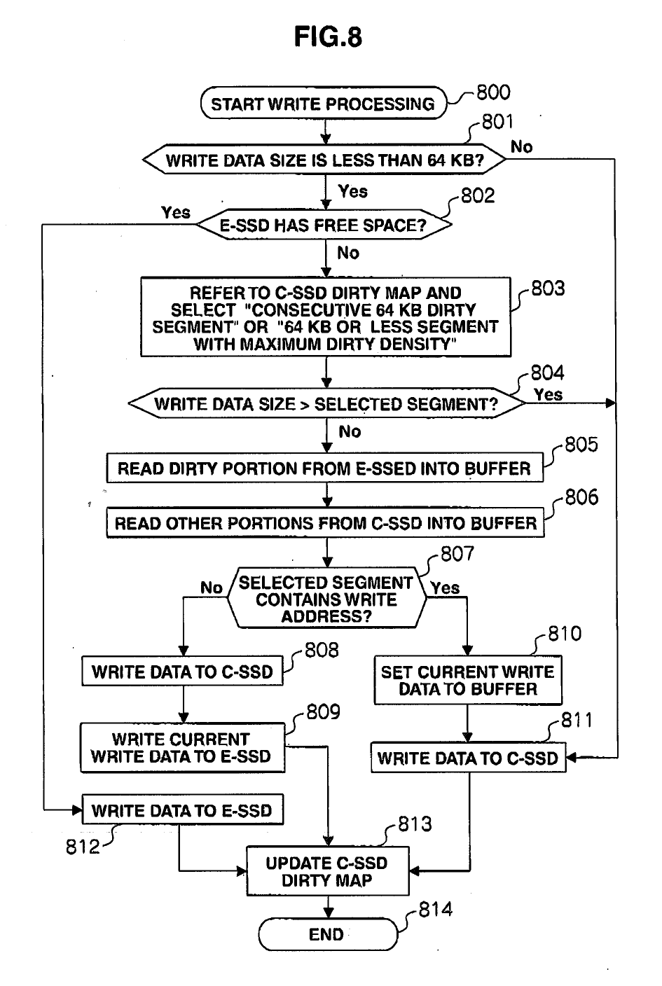

A write access processing sequence executed by the storage system 500 according to the first embodiment will be described below with reference to FIGS. 8-10.

If the MPU PK 513 (or 523) detects that there is dirty data in the cache PK 514 (or 524), the MPU PK 513 (or 523) starts processing for writing the dirty data to the SSD unit (800). First, the MPU PK 513 (or 523) judges whether or not the size of the write data is less than 64 KB or not (801). If step 801 returns a negative judgment (i.e., the size is 64 KB or more), the MPU PK 513 (or 523) writes the write data to part of the SSD unit with configuration A (811) and the processing proceeds to step 813. On the other hand, if step 801 returns an affirmative judgment (i.e., the size is less than 64 KB), the MPU PK 513 (or 523) judges whether or not there is free space in the SSD unit with configuration B (802). If step 802 returns an affirmative judgment (i.e., free space exists), the MPU PK 513 (or 523) writes the write data to a part of the SSD unit with configuration B (812) and the processing proceeds to step 813. On the other hand, if step 802 returns a negative judgment (i.e., no free space), the processing proceeds to step 803.

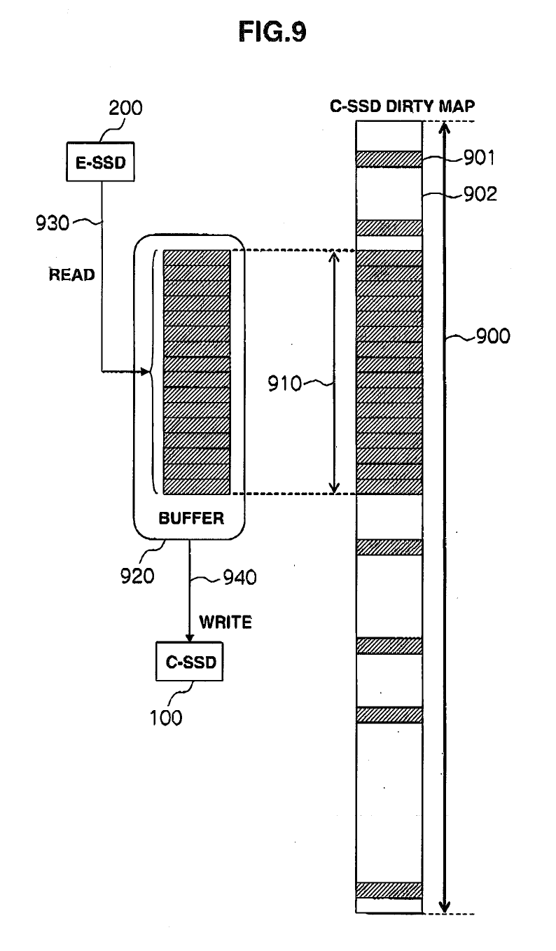

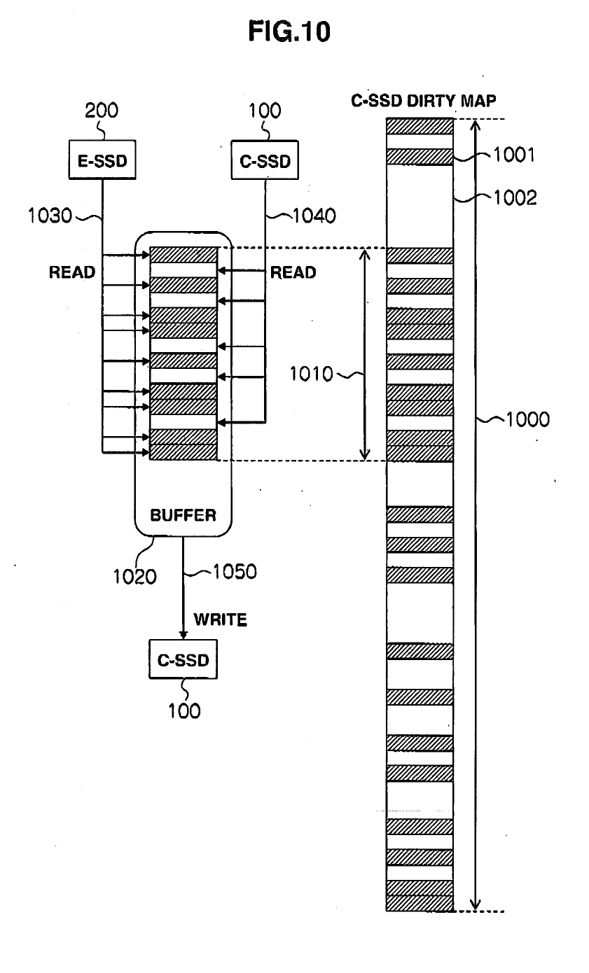

For the sake of step 803, the MPU PK 513 (or 523) has a map (C-SSD dirty map) for managing the portion of the address space in the SSD unit with configuration A for which the SSD unit with configuration B is used for substitute writing. This map is set in, for example, part of the cache PK 514 (or 524). As shown in FIG. 9 (FIG. 10), the C-SSD dirty map is a bit map in which “1” indicates the portion(s) 901 (1001) of the address space 900 (1000) in the SSD unit with configuration A for which the SSD unit with configuration B is used for substitute writing, and “0” indicates the portion(s) 902 (1002) for which substitute writing is not performed. When the storage system 500 is shut down, this map is stored also in part of the SSD unit with configuration B in a non-volatile manner. When the storage system 500 is activated, the map is read and set to part of the cache PK 514 (or 524).

In step 803, the MPU PK 513 (or 523) refers to this C-SSD dirty map and selects an address segment, like a segment 910 in FIG. 9, where consecutive 64 KB data is dirty (i.e., where the SSD unit with configuration B is used for substitute storage. If there is no such segment, the MPU PK 513 (or 523) selects an address segment of the highest dirty density portion, like a segment 1010 in FIG. 10, from among address segments of length 64 KB or less.

Subsequently, if the MPU PK 513 (or 523) selects the address segment like the segment 1010 in FIG. 10, it judges whether or not the size of the write data is larger than the length of that segment (804). If step 804 returns an affirmative judgment (i.e., the size of the write data is larger than the length of the segment), the MPU PK 513 (or 523) writes the write data to part of the SSD unit with configuration A (811), and the processing proceeds to step 813. On the other hand, if step 804 returns a negative judgment (i.e., the size of the write data is not larger than the length of the segment), the MPU PK 513 (or 523) reads data at dirty address portions in the selected segment from the SSD unit with configuration B into a buffer 920 (1020) (805, 930, 1030). For example, part of the cache PK 514 (or 524) is used as the buffer 920, 1020. If the MPU PK 513 (or 523) selects the address segment like the segment 1010 in FIG. 10, it reads data from clean (not dirty) address portions in the selected segment from the SSD unit with configuration A into the buffer 1020 (806, 1040).

Next, the MPU PK 513 (or 523) judges whether or not the selected segment contains the address of the current write data (807). If step 807 returns an affirmative judgment (i.e., the selected segment contains the address of the present write data), the MPU PK 513 (or 523) sets the write data to the buffer 920 (1020) (810) and writes the selected segment data in the buffer 920 (1020) to part of the SSD unit with configuration A (811, 940, 1050), and the processing then proceeds to step 813. On the other hand, if step 807 returns a negative judgment (i.e., the selected segment does not contain the address of the current write data), the MPU PK 513 (or 523) writes the selected segment data in the buffer 920 (1020) to part of the SSD unit with configuration A (808, 940, 1050) and also writes the present write data to the portion of the SSD unit with configuration B used as a substitute storage area for the selected segment (i.e., a portion that can be overwritten) (809), and the processing then proceeds to step 813.

In step 813, the MPU PK 513 (or 523) updates the C-SSD dirty map so that the address portions that were written to the SSD unit with configuration A in the above-described procedures are set to “clean (‘0’),” and the address portions that were written to the SSD unit with configuration B in the above-described procedures, are set to “dirty (‘1’).” Then, the write processing is terminated (814).

In the second embodiment, all the SSD units (such as 540-543 and 550-553) are configured as shown in FIG. 7 so that each of them is composed of the C-SSD 100, the E-SSD 200 with less capacity (for example, 5% in terms of capacity ratio) than the C-SSD 100, and an SSD adapter 700 connected to the C-SSD 100 and the E-SSD 200.

The SSD adapter 700 executes “reading” and “writing” of user data from and to each of the C-SSD 100 and the E-SSD 200. The SSD adapter 700 includes a processor 704, SATA interfaces 701, 702, a data transfer unit 7703, RAM 705, ROM 706, a SATA interface 707, and a SAS interface 708.

The data transfer unit 703 contains a bus logic and SAS and SATA control logics, and is connected to the other components 701, 702, 704-708. The processor 704 controls the data transfer unit 703 according to control firmware stored in the ROM 706. The RAM 705 functions as transfer data buffer memory and control firmware work memory. The data transfer unit 703 can accept asynchronous access from the two-port SATA interfaces 701, 702. The C-SSD 100 is connected to the SATA interface 707 via one port, and the E-SSD 200 is connected to the SAS interface 708 via two ports. The E-SSD 200 may be connected to the SAS interface 708 via one port, but redundancy is desired in order to enhance fault resistance.

Incidentally, since the backend switches 516, 526 support both the SAS interface and the SATA interface, the SATA interfaces 701, 702 contained in the SSD adapter 700 may be two-port SAS interfaces.

In the second embodiment, the SSD adapter 700 executes write processing—basically performing substitute writing of data less than 64 KB, from among data to be written to the C-SSD 100, to the E-SSD 200, and moving plural pieces of that data as a set from the E-SSD 200 to the C-SSD 100 as necessary.

A write access processing sequence executed by the storage system 500 according to the second embodiment is basically the same as the write access processing sequence according to the first embodiment as shown in FIGS. 8-10. However, there are some differences, as outlined below.

First, the main component executing the processing is not the MPU PK 513, 523, but the SSD adapter 700 in each SSD unit. Also, the buffer in steps 805, 806, 810 and the C-SSD dirty map are located not in part of the cache PK 514, 524, but in the RAM 704 of each SSD adapter 700.

The second embodiment is superior to the first embodiment in that the present invention's range of utilization is included in small-scale devices called “SSD units” and, therefore, it is only necessary to provide the existing various storage systems with the common SSD units and it is unnecessary to change the write control firmware for each existing storage system, which means that barriers to introducing the SSD units and the write access processing according to the second embodiment are low.

The write access processing sequences according to the two embodiments described above have the effect of enhancing the write performance of the storage system 500 and improving the rewritable life of the flash memory 120, 220. The scale of the effect will be explained below by showing two access patterns and comparing a conventional storage system composed solely of the C-SSD 100 with the storage system 500 of this invention.

The first example is the case where 1 KB write-back data outflows intermittently from the cache PK 514 (or 524) and these pieces of data finally fill a 64 KB continuous address segment. Conventionally, 1 KB data is written to the C-SSD 64 times, so a device processing time of “64 times×8.8 ms=563.2 ms” is required. According to this invention, 1 KB data is written to the E-SSD at least 64 times, and subsequently 64 KB data is written to the C-SSD once, so a device processing time of only “64 times×0.13 ms+one time×8 ms=16.32 ms” is required. In both cases, the amount of time required for, for example, data transfer needs to be added to the above-mentioned processing time to obtain the effective processing time, but the scale of the time reduction effect of the present invention is still evident. Also, the total flash memory rewrite amount in the conventional storage system is as many as “64 times×64 KB (C-SSD)=4096 KB,” while the total flash memory rewrite amount in the present invention is only “64 times×1 KB (E-SSD)+one time×64 KB (C-SSD)=128 KB.”

The second example is the case where 1 KB write-back data outflows intermittently from the cache PK 514 (or 524) and these pieces of data finally fill a 63 KB continuous address segment to include 32 pieces of data with 1 KB intervals. Conventionally, 1 KB data is written to the C-SSD at least 32 times, so a device processing time of “32 times×8.8 ms=281.6 ms” is required. According to the present invention, 1 KB data is written to the E-SSD at least 32 times, and subsequently 1 KB data is read from the C-SSD 31 times and 63 KB data is written to the C-SSD once, so a device processing time of only “32 times×0.13 ms+31 times×0.05 ms+one time×8 ms=13.71 ms” is required. In both cases, the amount of time required for, for example, data transfer needs to be added to the above-mentioned processing time to obtain the effective processing time, but the scale of the time reduction effect of the present invention is still evident. Also, the total flash memory rewrite amount in the conventional storage system is as much as “32 times×64 KB (C-SSD)=2048 KB,” while the total flash memory rewrite amount in the present invention is only “32 times×1 KB (E-SSD)+one time×64 KB (C-SSD)=96 KB.”

As described above, this invention enhances the performance and extends the lifespan by approximately 10 times compared to a conventional storage system.

The scale of the effect of the first embodiment depends on the ratio of the total storage capacity of the SSD units having the configuration shown in FIG. 6A to the total storage capacity of the SSD units having the configuration shown in FIG. 6B. Also, the scale of the effect of the second embodiment depends on the ratio of the storage capacity of the C-SSD 100 to the storage capacity of the E-SSD 200. In either case, as the E-SSD ratio increases, many pieces of small-unit write data can be stored in the E-SSD, so the write performance and the rewritable life of the entire storage system will be enhanced. However, in consideration of cost performance (cost vs. performance, and cost vs. life), the largest possible E-SSD ratio may not be the best option.

If the usage environment is one where writing small-unit data is concentrated in about 10% (at the most) of the user data capacity of the entire storage system 500, sufficient effect can be obtained merely by employing a configuration with an E-SSD ratio of about 10% of the entire storage system. However, even if the E-SSD ratio is set to more than 10%, the effect will not further increase to match any cost increase due to the addition of E-SSDs. As stated at the beginning of this section, the price of an E-SSD is approximately five times the price of a C-SSD with the same capacity. As a result, a 10% addition of E-SSDs will result in a 50% cost increase, and the cost of driving the storage system will increase 1.5 times. Even so, as stated in the aforementioned examples, the performance will be enhanced and the lifespan will be extended approximately O-fold. In other words, the present invention is worth implementing because it optimizes cost performance by adding an appropriate proportion of E-SSDs based on the usage environment, to a low-priced storage system that is mainly composed of low-priced C-SSDs.

If the usage environment of the storage system 500 changes with the passage of operation time and the area to which small-unit data is written in a concentrated manner expands relative to the entire user data capacity, dirty density of certain address segments to which data is written back reduces, thereby decreasing the effect of the present invention on the performance enhancement and the lifespan extension. If further E-SSDs are added to the storage system 500 in the above-described circumstances, it is possible to maintain the effect on the performance enhancement and lifespan extension. In that situation, if the MPU PKs 513, 523 analyze distribution of a number of small-unit data write times in a user data address space and determines that an addition of E-SSDs will make it possible to maintain the effect on the performance enhancement and lifespan extension, a message prompting the user to add E-SSDs may be given to the user through the maintenance client 504.

In the above description, “64 KB” is used as the standard to judge whether write data should be written to the C-SSD or the E-SSD, and as the write-back size standard. However, this value indicates a memory management unit that can be changed according to a C-SSD memory management method. Therefore, this invention does not limit the value of the memory management unit to a specific numeric value. The memory management unit for a C-SSD can be obtained by contacting the manufacturer of that C-SSD. If the memory management unit cannot be obtained, the user should conduct a C-SSD write performance test and draw a characteristic graph, as shown in FIG. 3B, showing the relationship between the write data size and the performance (or processing time). The C-SSD memory management unit can be estimated by finding the point where the slope of the performance curve changes significantly (or the point where the processing time decreases and stays relative to a reduction in size of the write data). This estimated value may be applied to the write destination judgment standard or the write-back size standard value.

The above description has shown the embodiments of a storage system using flash memory as storage media. However, it is apparent that the above-described invention can be also implemented in a storage system using other kinds of non-volatile memory with a limited rewritable life as storage media, and that the effect of the present invention can be obtained in such storage system.

The present invention can utilized in a wide variety of storage systems and data write methods for such storage systems.

While the invention has been described with respect to a limited number of embodiments, those skilled in the art, having benefit of this disclosure, will appreciate that other embodiments can be devised that do not depart from the scope of the invention as disclosed herein. Accordingly, the scope of the invention should be limited only by the attached claims.

What is claimed is:

1. A storage system including a first non-volatile memory device with specified performance and a second non-volatile memory device with a higher performance than the specified performance, the storage system comprising:
a size-maintenance unit for maintaining the size of a memory management unit to manage memory in the first non-volatile memory device; and
a control unit for, in response to a write request from a host system, comparing the size of write data, for which the write request was made, with the size of the memory management unit; and temporarily writing the write data to the second non-volatile memory device if the size of the write data is smaller than the size of the memory management unit; or writing the write data to the first non-volatile memory device if the size of the write data is equal to or larger than the size of the memory management unit.

2. The storage system according to claim 1, wherein the control unit refers to a plurality of address values for the write data temporarily written to the second non-volatile memory device; selects an address segment that is equal to the size of the memory management unit and in which the referred address values are consecutive; and copies write data contained in that address segment from the second non-volatile memory device to the first non-volatile-memory device.

3. The storage system according to claim 1, wherein the control unit refers to a plurality of address values for the write data temporarily written to the second non-volatile memory device; selects an address segment that is equal to or smaller than the size of the memory management unit and contains a maximum number of the address values; reads write data contained in the address segment from the second non-volatile memory device; reads, from the first non-volatile memory device, write data that can be read into the address segment; creates consecutive data from the write data read as described above; and writes the created consecutive data to the first non-volatile memory device.

4. The storage system according to claim 3, wherein when the write data read from the first non-volatile memory device and the write data read from the second non-volatile memory device are made to be consecutive, and consecutive data equal to or less than the amount of data stored in the address segment is read.

5. The storage system according to claim 1, wherein the size of the memory management unit for the second non-volatile memory device is smaller than the size of the memory management unit for the first non-volatile memory device.

6. The storage system according to claim 1, wherein a difference between the performance of the first non-volatile memory device and the performance of the second non-volatile memory device at least includes a difference in write performance between these devices.

7. The storage system according to claim 1, wherein the first non-volatile memory device is a consumer-type semiconductor storage apparatus, and the second non-volatile memory device is an enterprise-type semiconductor storage apparatus.

8. A data write method for a storage system including a first non-volatile memory device with specified performance and a second non-volatile memory device with a higher performance than the specified performance, the data write method comprising the steps of;
maintaining the size of a memory management unit to manage memory in the first non-volatile memory device; and
in response to a write request from a host system, comparing the size of write data, for which the write request was made, with the size of the memory management unit; and
temporarily writing the write data to the second non-volatile memory device if the size of the write data is smaller than the size of the memory management unit; or
writing the write data to the first non-volatile memory device if the size of the write data is equal to or larger than the size of the memory management unit.

9. The storage system data write method according to claim 8, further comprising the steps of:
referring to a plurality of address values for the write data temporarily written to the second non-volatile memory device;
selecting an address segment that is equal to the size of the memory management unit and in which the referred address values are consecutive; and
copying data contained in that address segment from the second non-volatile memory device to the first non-volatile memory device.

10. The storage system data write method according to claim 8, further comprising the steps of:
referring to a plurality of address values for the write data temporarily written to the second non-volatile memory device;
selecting an address segment that is equal to or smaller than the size of the memory management unit and contains a maximum number of the address values, and reading write data contained in the selected address segment from the second non-volatile memory device;
reading, from the first non-volatile memory device, write data that can be read into the address segment; and
creating consecutive data from the write data read as described above, and writing the created consecutive data to the first non-volatile memory device.

11. The storage system data write method according to claim 10, wherein when the write data read from the first non-volatile memory device and the write data read from the second non-volatile memory device are made to be consecutive, and consecutive data equal to or less than the amount of data stored in the address segment is read.

12. The storage system data write method according to claim 8, wherein the size of the memory management unit for the second non-volatile memory device is smaller than the size of the memory management unit for the first non-volatile memory device.

13. The storage system data write method according to claim 8, wherein a difference between the performance of the first non-volatile memory device and the performance of the second non-volatile memory device at least includes a difference in write performance between these devices.

14. The storage system data write method according to claim 8, wherein the first non-volatile memory device is a consumer-type semiconductor storage apparatus, and the second non-volatile memory device is an enterprise-type semiconductor storage apparatus.

15. An adapter apparatus used for a storage system, the adapter apparatus comprising:
a first interface connected to an interface of a first non-volatile memory device with specified performance;
a second interface connected to an interface of a second non-volatile memory device with a higher performance than the specified performance;
a size-maintenance unit for maintaining the size of a memory management unit to manage memory in the first non-volatile memory device; and
a control unit for, in response to a write request from a host system, comparing the size of write data, for which the write request was made, with the size of the memory management unit; and temporarily writing the write data to the second non-volatile memory device if the size of the write data is smaller than the size of the memory management unit; and writing the write data to the first non-volatile memory device if the size of the write data is equal to or larger than the size of the memory management unit.

16. The adapter apparatus according to claim 15, wherein the first interface's specifications are different from the second interface's specifications, and the first interface is an interface with the storage system, and
the adapter apparatus further comprises a third interface to make the second interface compatible with the interface with the storage system.

17. The adapter apparatus according to claim 16, wherein the first interface is a serial ATA interface, and the second interface is a SAS interface.

18. The adapter apparatus according to claim 15, wherein the size of the memory management unit for the second non-volatile memory device is smaller than the size of the memory management unit for the first non-volatile memory device.
